(19) United States
(12) Patent Application Publication
(10) Pub. No.: US 2002/0151620 A1
(43) Pub. Date: Oct. 17, 2002

(54) Adhesives for increasing the adhesion between rubbers and reinforcing materials

(76) Inventors: Bernhard Jansen, Koln (DE); Rudiger Schubart, Bergisch Gladbach (DE); Stefan Grabowski, Dormagen (DE); Hermann-Josef Weidenhaupt, Pulheim (DE)

Correspondence Address: BAYER CORPORATION, PATENT DEPARTMENT, 100 BAYER ROAD, PITTSBURGH, PA, 15205, US

(21) Appl. No.: 10/061,860

(22) Filed: Feb. 1, 2002

(30) Foreign Application Priority Data
Feb. 7, 2001 (DE) 10105402.5

(51) Int. Cl. C09J 4/00

(52) U.S. Cl. 523/176

(57) ABSTRACT

The present invention relates to adhesives for increasing the adhesion between rubbers and reinforcing materials based on metals, organic polymers or ceramic materials and the use of adhesives to produce rubber mixtures or rubber vulcanizates containing reinforcing materials.

The adhesives according to the invention are characterized by simple and environmentally friendly processing combined with a very good adhesive effect.

### FIELD OF THE INVENTION

The subject of the present invention is adhesives for increasing the adhesion between rubbers and reinforcing materials based on metals, organic polymers or ceramic materials and the use of the adhesives for producing rubber mixtures or rubber vulcanizates containing reinforcing materials.

### BACKGROUND OF THE INVENTION

Many industrial rubber articles, for example pneumatic tires, conveyor belts, drive belts, rubberized fabrics or high pressure hoses are equipped with reinforcing inserts, called reinforcing materials in this case, which contain metallic materials, organic polymer materials or ceramic materials, preferably in the form of filaments, fibers, wires, cords, strips or combinations thereof.

To ensure that the aforementioned rubber articles are efficient and have a good useful life, a strong and durable bond is required between the reinforcing materials and the rubber.

This may only be achieved, for example in the case of the insertion of steel cord as reinforcing material, without a further adhesive if the filaments of the steel cord are plated with a thin layer of brass or another alloy with the main components being copper and zinc or pure zinc.

The steel cord, which is equipped in this way, is vulcanized directly into the generally particularly adhesion-promoting rubber mixture containing rubber mixture additives. In the case of textile reinforcing materials, fibers surface-treated in a suitable form are conventionally used.

The most common additives for improving the adhesive force, hereinafter designated adhesives, may be divided into two groups in accordance with their chemical structure.

The first group contains all adhesives, which are only effective as multi-component systems. Common thereto is the fact that they contain highly reactive silicas.

The further components are resorcinol or resorcinol formaldehyde condensation products and formaldehyde-splitting compounds such as hexamethylenetetramine, etherified esterified methylol melamines with various degrees of etherification or esterification and the condensation products thereof.

While these systems provide good adhesion, they sometimes cause vapors and bad odors during vulcanization. The processability in the mixing machines, for example on the mixing mill, is also considerably impaired as the resorcinol tends toward sublimation, particularly at temperatures close to the melting point.

The second group primarily contains organometallic compounds, with the compounds of cobalt predominating. Cobalt soaps, are also conventional as liquid dryers in the paint industry, have primarily been used for a long time.

Therefore, in FR-A 1 323 934, various cobalt salts, for example cobalt stearate, cobalt linolate or cobalt naphthenate are claimed. Boronorganic cobalt compounds, in accordance with U.S. Pat. No. 3,296,242, are suitable. Copper, nickel, lead or zinc can also be considered as metals in addition to cobalt (cf. DE-A 2,303,674, DE-A 2,447,853 or U.S. Pat. No. 4,154,911).

Further compound classes are nickel and cobalt complexes of succincyl succinic acid esters (EP-A 0 003 820) or transition metal salts of certain 1, 2 diols (EP-A 0 009 000).

Simple organic salts do not generally improve the adhesion of a rubber compound to metallic carrier materials, but rather, in contrast, as a rubber poison, often reduce the stability of the rubber/metal compounds.

The harmful effect of the adhesives used hitherto is also worth mentioning. Thus, resorcinol and resorcinol polycondensates tend to form harmful vapors during processing due to the sublimation of the resorcinol. Cobalt and bioavailable cobalt compounds are also carcinogenic.

### SUMMARY OF THE INVENTION

Therefore, the object of the invention is to provide an adhesive system for improved rubber adhesion to reinforcing materials which does not exhibit the aforementioned drawbacks or does not exhibit them to the same extent and which, in particular, does not contain any heavy metals such as cobalt or nickel either.

The invention, therefore, relates to adhesives for increasing the adhesion between rubbers and reinforcing materials wherein compounds are contained which a) can be obtained by reacting carboxylic acids with compounds which have one or more hydroxyl groups or one or more amino groups or one or more hydroxyl and one or more amino groups and additionally one or more carbon-carbon double or triple bonds in the molecule and optionally, with compounds which contain one or more hydroxyl groups or one or more primary or secondary amino groups or one or more hydroxyl and one or more primary or secondary amino groups and additionally, at least one tertiary amino group in the molecule, or b) can be obtained by reacting polyisocyanates with compounds which contain one or more hydroxyl groups or one or more amino groups or one or more hydroxyl and one or more amino groups and additionally, one or more carbon-carbon double or triple bonds in the molecule and optionally, with compounds which contain one or more hydroxyl groups or one or more primary or secondary amino groups or one or more hydroxyl and one or more primary or secondary amino groups and additionally at least one tertiary amino group in the molecule.

### DETAILED DESCRIPTION OF THE INVENTION

Practically, all known carboxylic acids, in particular those which contain at least two carboxylic groups, preferably 2 to 4 carboxylic groups in the molecule and 2 to 40 carbon atoms, preferably 4 to 36 carbon atoms in the molecule are considered as carboxylic acids.

The carboxylic acids which can be used according to the present invention can, of course, be substituted by the most varied of groups, such as hydroxyl groups, halogens, nitro groups, alkyl groups or aryl groups.

The substituents can be present singly or multiply in the above-mentioned carboxylic acids. It is also possible to use carboxylic acids of this type which are interrupted singly or multiply, by heteroatoms, such as oxygen, sulfur or nitrogen and unsaturated structures such as double bonds.

Preferred examples of carboxylic acids are: maleic acid, fumaric acid, itaconic acid, oxalic acid, malonic acid, succinic acid, glutaric acid, adipic acid, suberic acid, azelaic acid, sebacic acid, dodecanedioic acid, malic acid, tartaric acid, butanetetracarboxylic acid, diglycol acid, thiodiglycol acid, citric acid, mucic acid, camphoric acid, hexahydroterephthalic acid, HET acid, phthalic acid, isophthalic acid, terephthalic acid, tetrachlorophthalic acid, 4-chloro-1,3-benzenedicarboxylic acid, 1,3,5-benzenetetracarboxylic acid, pyromellitic acid, 4-phenylphthalic acid, 1,4,5,8-naphthalenetetracarboxylic acid and dimeric fatty acid as described in the monograph: “THE DIMER ACIDS”, edited by Erward C. Leonhard, Humko Sheffield Chemical, in particular maleic acid, fumaric acid, itaconic acid, malonic acid, succinic acid, adipic acid, phthalic acid, isophthalic acid and the dimeric fatty acids described in the monograph.

Maleic acid, fumaric acid, malonic acid, adipic acid and dimeric fatty acids are most preferably used.

Of course, it is possible to use mixtures of the above-mentioned carboxylic acids.

Examples of compounds which exhibit one or more hydroxyl groups or one or more amino groups or one or more hydroxyl and one or more amino groups and additionally one or more carbon-carbon double or triple bonds in the molecule are: allyl alcohol, 2-methyl-3-buten-2-ol, olein alcohol, propargyl alcohol, 3-butin-2-ol, 2-methyl-3-butin-2-ol, allylamine and diallylamine, preferably allyl alcohol, olein alcohol and propargyl alcohol.

Allyl alcohol, olein alcohol, allylamine and diallylamine are preferably used for the reaction with the polyisocyanates described hereinafter.

The amino and hydroxy compounds just mentioned can be used both individually and in a mixture with one another.

Compounds which can be used in addition to the above-mentioned compounds containing hydroxyl groups or amino groups are, as mentioned, those which contain one or more hydroxyl groups or one or more primary or secondary amino groups or one or more hydroxyl and one or more primary or secondary amino groups and additionally at least one tertiary amino group in the molecule, examples thereof being: N,N-dimethyl- and N,N-diethylethanolamine, 2-(2-dimethyl-aminoethoxy)-ethanol, 2-(2-diethyl-aminoethoxy)-ethanol, N,N-dibutylaminoethanol, N-methyidiethanolamine, N-butyldiethanolamine, bis-(2-hydroxyethyl)oleylamine, triethanolamine, (3-hydroxypropyl)-dimethylamine, (2-hydroxypropyl)-dimethylamine, 1-diethylamino-2-propanol, bis-(2-hydroxypropyl)-methylamine, tris-(2-hydroxypropyl)-amine, N,N-diethyl-1,2-ethaneamine, N,N′,N″-trimethyldiethylenetriamine, N,N-dimethyl-1,3-propanediamine, N,N-diethyl-1,3-propanediamine, bis-(3-aminopropyl)-methylamine.

N,N-dimethyl- and N,N-diethylethanolamine, N,N-dibutylaminoethanol, 2-(2-dimethyl-aminoethoxy)-ethanol are preferred. These compounds can be used both individually and in a mixture with one another.

The known modified or unmodified aliphatic, cycloaliphatic, araliphatic or aromatic polyisocyanates, both individually and in a mixture with one another, can be used as polyisocyanates. Aliphatic, cycloaliphatic, araliphatic and/or aromatic polyisocyanates which exhibit uretdione and/or isocyanurate- and/or allophanate and/or biuret- and/or oxadiazine structures and which can be produced in the known manner from the above-mentioned polyisocyanates are preferably used. Examples of aliphatic or cycloaliphatic diisocyanates are: 1,4-diisocyanatobutane, 1,6-diisocyanatohexane, 1,5-diisocyanato-2,2-dimethyl-pentane, 2,2,4- and 2,4,4-trimethyl-1,6-diisocyanatohexane, 1,3- and 1,4-diisocyanatocyclohexane, 1-isocyanato-3,3,5-trimethyl-5-isocyanato-methyl-cyclohexane, 1-isocyanato-1-methyl-4-isocyanatomethyl-cyclohexane, 4,4-diisocyanato-dicyclohexylmethane or any mixtures of the aforementioned diisocyanates. 1,6-diisocyanatohexane, 1,4-diisocyanatocyclohexane and 1-isocyanato-3,3,5-trimethyl-5, isocyanato-methyl-cyclohexane are preferred.

Toluylene diisocyanate and its isomer mixtures, 1,5-diisocyanatonaphthalene and diphenylmethane diisocyanates are examples of aromatic polyisocyanates.

As mentioned previously, the polyisocyanates mentioned by name can be modified with the aforementioned structures.

Polyisocyanates which are modified by uretdione and/or isocyanurate structures and/or allophanate and/or biuret structures are preferably used.

To produce the adhesives according to the present invention, the above-mentioned carboxylic acids are reacted, individually or in a mixture with one another, with the above-mentioned unsaturated compounds containing hydroxyl and/or amino groups in such a way that 0.1 to 1.0 mol of the unsaturated compounds containing hydroxyl and/or amino groups and 0.1 to 0.9 mol of the compounds containing tert.-amino groups are used on 1 mol carboxyl groups. 0.3 to 1.0 mol of the compounds containing unsaturated hydroxyl and/or amino groups and 0.3 to 0.7 mol of the compounds containing tert.-amino groups are preferably used on 1 mol carboxyl groups.

To produce the adhesives according to the present invention based on polyisocyanates, the above-mentioned polyisocyanates are reacted with the unsaturated compounds containing hydroxyl and/or amino groups in such a way that 0.1 to 1 mol of the unsaturated compounds containing hydroxyl and/or amino groups and 0.3 to 0.7 mol of the compounds containing tert.-amino groups are allotted to 1 mol isocyanate groups. 0.3 to 1 mol of the compounds containing unsaturated hydroxyl and/or amino groups and 0.3 to 0.7 mol of the compounds containing tert.-amino groups are preferably used on 1 mol isocyanate groups.

Production of the adhesives according to the present invention from the above-mentioned components is known and can, for example, be carried out in accordance with the melt ester process in a solvent-free manner when using carboxylic acids or in the form of an azeotropic, an extractive esterification using dehydrating means. The esterification reactions are described, for example, in Organikum, 14th edition, VEB Deutscher Verlag der Wissenschaften, Berlin, 1965, page 440 to 443. Of course, a mode of operation for esterification purposes is also possible which proceeds from the anhydrides of the above-mentioned carboxylic acids.

Reaction of the above-mentioned polyisocyanates with the compounds containing hydroxyl or amino groups is also state of the art and is described, for example, in Houben-Weyl, Methoden der Organischen Chemie, Makromolekulare Stoffe, volume E20, part 2, page 1587 to 1609.

The present invention also relates to the use of the adhesives according to the present invention to produce rubber mixtures or rubber vulcanizates containing reinforcing materials which can exist in the most varied of forms.

The known reinforcing materials as they are used to produce corresponding rubber articles can be considered as reinforcing materials. Examples include steel cord, steel cord in galvanized or brass-plated form, textile fibers, such as cellulose fibers, viscose fibers, polyester fibers, polyamide fibers, aramide fibers and polyethylene fibers, carbon fibers or glass fibers and fibers based on ceramic materials. The reinforcing materials can optionally be surface-modified by the current processes.

Both natural rubber and the conventional synthetic rubbers can be considered as rubbers, which can be used to produce the rubber mixtures or rubber vulcanizates containing reinforcing materials. Rubbers based on butadiene, butadiene/acrylic acid C₁ to C₄ alkylesters, chloroprene, isoprene or isoprene copolymers, styrene/butadiene copolymers, styrene/butadiene/acrylonitrile copolymers, isobutylene/isoprene copolymers, butadiene/acrylonitrile copolymers, partially hydrogenated or completely hydrogenated butadiene/acrylonitrile copolymers, ethylene/propylene/diene copolymers are examples.

Of course, the above-mentioned rubbers can be used alone or in mixtures with one another. The most preferred mixture ratio of the rubbers to be used is determined in accordance with the subsequent application of the rubber mixtures or rubber vulcanizates.

Natural rubber and rubbers based on butadiene and styrene/butadiene copolymers are preferably used.

The adhesives according to the present invention are conventionally used in quantities of 0.01 to 20 parts by weight, preferably in quantities of 0.05 to 5 parts by weight, most particularly preferably in quantities of 0.1 to 1.5 parts by weight, based on 100 parts by weight rubber (=phr) to produce rubber mixtures or rubber vulcanizates.

Of course, it is possible to combine the adhesives according to the present invention with the adhesive systems hitherto used in practice.

To produce the rubber mixtures or rubber vulcanizates containing reinforcing materials by using the adhesives according to the present invention, the known rubber auxiliary aids and cross-linking agents or cross-linking systems can be admixed to the rubber mixtures in the quantities known for this purpose.

Rubber auxiliary agents and cross-linking agents or cross-linking systems of this type are described in more detail, for example, in Ullmann's Encyclopedia of Industrial Chemistry, fifth completely revised edition, volume A23, page 365 to 420.

The adhesives according to the present invention and rubber mixtures containing reinforcing materials are vulcanized in the conventional manner at temperatures in the range of 100 to 200° C., preferably at 130 to 180° C., optionally under pressure of 10 to 200 bar.

Rubber articles of all kinds containing reinforcing materials can be produced with the adhesives according to the invention, for example conveyor belts, driving belts, hoses, tire components or rubberized fabrics.

### EXAMPLES

The rubber polymers and chemicals are commercial products from Bayer AG Rubber Division, unless otherwise stated. The rubber-mechanical tests were carried out to DIN 53523, 53504, 53505 53512, 53513 and ASTM D 2084.

The adhesion test was carried out to ASTM D 2229.

### Example 1

Production of the a) and b) Type Adhesives

Adhesive a):

Maleic acid diallylester, which can be obtained from Fluka under Article No. 63230.

Adhesive b):

100 parts by weight of an isocyanate with the NCO content of 22.5%, substantially containing trimeric hexamethylene diisocyanate, were stirred at ambient temperature with 29.7 parts by weight allyl alcohol. The reaction mixture was then heated to 60° C. and stirred until an isocyanate absorption is no longer visible in the infrared spectrum. The resulting product was a highly viscous honey yellow substance.

### Example 2

Production of Adhesive Mixtures

The components polymer, filler and additives including the a) and b) type adhesives according to the invention were mixed in a 1.5 l closed mixer from Werner & Pfleiderer (GK 1.5 E model):

Sulfur and accelerator at approximately 60 to 90° C. were subsequently admixed on a roller.

Diverse specimens were produced in a manner conventional to the person skilled in the art in a press vulcanization process at 150° C.

Specimens were subsequently punched out of these plates in a conventional manner in order to carry out the rubber-mechanical tests mentioned in Table 1.

In addition, composite specimens of the rubber mixtures and brass-plated steel cord were produced and vulcanized. This also took place in a manner conventional to the person skilled in the art to ASTM D 2229.

Components used:

| | |
|---|---|
| Vulkanox ® HS | dihydroquinoline (polymerized), Bayer AG |
| | product |
| Vulkacit ® DZ | sulfenamide, Bayer AG product |
| Koresin ® Powder | tackifier resin, BASE AG product |
| Rhenocure ® IS 90-20 | insoluble sulfur 80%, Rhein Chemie Rheinau |
| | product |
| TSR 5 Defo 700 | natural rubber |
| Corax ® N326 | carbon black, Degussa-Hüls AG product |
| Stearic acid | Henkel KGaA product |
| Zinkoxyd aktiv ® | Bayer AG product |
| Steel cord | Bekaert AG product |

The individual mixture compositions are given in the following Table 1:

TABLE 1

| | Comparison | Mixture A | Mixture B |
|---|---|---|---|
| | mixture | (invention) | (invention) |
| TSR 5 Defo 700 | 100 | 100 | 100 |
| Corax N 326 | 60 | 60 | 60 |
| Stearic acid | 2 | 2 | 2 |
| Koresin owder | 4 | 4 | 4 |
| Vulkanox HS | 0.8 | 0.8 | 0.8 |
| Zinkoxyd aktiv | 8 | 8 | 8 |
| a) type adhesive (invention) | | 0.63 | |
| b) type adhesive (invention) | | 0.63 | |
| Vulkacit DZ | 1 | 1 | 1 |
| Rhenocure IS 90-20 | 5 | 5 | 5 |

The rubber-mechanical properties of the rubber mixtures and the vulcanizates and reinforced rubber specimens produced therefrom are listed in the following tables 2 to 4:

TABLE 2
Mixture properties

| | Comparison | Mixture A | Mixture B |
|---|---|---|---|
| | mixture | (invention) | (invention) |
| Mooney Viscosity [ME] | 56 | 76 | 54 |
| Mooney Scorch (min) | 12.5 | 14.6 | 12.3 |
| ts 01 [min] | 1.44 | 1.29 | 1.52 |
| t 90 [min] | 17.31 | 16.75 | 17.96 |

TABLE 3
Vulcanizate properties

| | Comparison | Mixture A | Mixture B |
|---|---|---|---|
| | mixture | (invention) | (invention) |
| Module 100 [MPa] | 3.7 | 4.2 | 3.8 |
| Module 300 [MPa] | 16.2 | 18.2 | 16.0 |
| Strength [MPa] | 27.2 | 25.5 | 27.1 |
| Elongation at break [%] | 457 | 408 | 459 |
| Tear propagation resistance | 50.3 | 47.0 | 52.8 |
| 23° C. | | | |
| Tear propagation resistance | 34.7 | — | 35.2 |
| 70° C. | | | |
| Shore A hardness, 23° C. | 72 | 75 | 74 |
| Shore A hardness, 70° C. | 70 | 70 | 70 |
| Elasticity 23° C. [%] | 41.6 | 42.7 | 41.0 |
| Elasticity 70° C. [%] | 54.0 | 57.1 | 50.2 |

TABLE 4
Adhesion properties

| | Comparison | Mixture A | Mixture B |
|---|---|---|---|
| | mixture | (invention) | (invention) |
| Peel force [N] | 670 | 746 | 722 |
| Cord covering* | 4 | — | 3 |

*1 = base; 2 = partially covered; 3 = completely covered; 4 = structural fracture in the rubber

Generally, a high extraction force with a high degree of coverage with the precondition that the remaining properties of rubber mixture and vulcanizate are comparable are valid criteria for rubber mixtures which are suitable for producing by vulcanization composite materials with the above-mentioned reinforcing materials. The examples show that the adhesives according to the present invention and the adhesive mixtures produced therewith are eminently suitable for this purpose.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An adhesive composition for increasing the adhesion between rubbers and reinforcing materials, wherein said adhesive composition comprises compounds which are obtained by reacting carboxylic acids with compounds which have one or more hydroxyl groups or one or more amino groups or one or more hydroxyl and one or more amino groups and additionally one or more carbon-carbon double or triple bonds in the molecule and optionally with compounds which contain one or more hydroxyl groups or one or more primary or secondary amino groups or one or more hydroxyl and one or more primary or secondary amino groups and additionally at least one tertiary amino group in the molecule.

2. An adhesive composition according to claim 1, wherein the carboxylic acids are reacted with the unsaturated compounds containing hydroxyl and/or amino groups in such a way that 0.1 to 1.0 mol of the compounds containing hydroxyl and/or amino groups and 0.1 to 0.9 mol of the compounds containing tert-amino groups are used on 1 mol carboxylic groups.

3. Rubber mixtures or rubber vulcanizates containing reinforcing materials which comprise an adhesive composition for increasing the adhesion between rubbers and reinforcing materials, wherein said adhesive composition comprises compounds which are obtained by reacting carboxylic acids with compounds which have one or more hydroxyl groups or one or more amino groups or one or more hydroxyl and one or more amino groups and additionally one or more carbon-carbon double or triple bonds in the molecule and optionally with compounds which contain one or more hydroxyl groups or one or more primary or secondary amino groups or one or more hydroxyl and one or more primary or secondary amino groups and additionally at least one tertiary amino group in the molecule.

4. An adhesive composition for increasing the adhesion between rubbers and reinforcing materials, wherein said adhesive composition comprises compounds which are obtained by reacting polyisocyanates with compounds which contain one or more hydroxyl groups or one or more amino groups or one or more hydroxyl and one or more amino groups and additionally one or more carbon-carbon double or triple bonds in the molecule and optionally with compounds which contain one or more hydroxyl groups or one or more primary or secondary amino groups or one or more hydroxyl and one or more primary or secondary amino groups and additionally at least one tertiary amino group in the molecule.

5. An adhesive composition according to claim 4, wherein the polyisocyanates are reacted with the unsaturated compounds containing hydroxyl and/or amino groups and with the compounds containing tert.-amino groups in such a way that 0.1 to 1.0 mol of the unsaturated compounds containing hydroxyl and/or amino groups and 0.3 to 0.7 of the compounds containing tert.-amino groups are allocated to 1 mol isocyanate groups.

6. Rubber mixtures or rubber vulcanizates containing reinforcing materials which comprise an adhesive composition for increasing the adhesion between rubbers and reinforcing materials, wherein said adhesive composition comprises compounds which are obtained by reacting polyisocyanates with compounds which contain one or more hydroxyl groups or one or more amino groups or one or more hydroxyl and one or more amino groups and additionally one or more carbon-carbon double or triple bonds in the molecule and optionally with compounds which contain one or more hydroxyl groups or one or more primary or secondary amino groups or one or more hydroxyl and one or more primary or secondary amino groups and additionally at least one tertiary amino group in the molecule.
